(19) United States
(12) Patent Application Publication
(10) Pub. No.: US 2019/0325856 A1
(43) Pub. Date: Oct. 24, 2019

(54) MULTI-SOUND EMITTING TOY AND METHOD FOR MANUFACTURE

(71) Applicant: Caitec Corporation, Halethorpe, MD (US)

(72) Inventors: John James Stone, Golden, CO (US); Amy E. Stone, Golden, CO (US)

(21) Appl. No.: 16/390,858

(22) Filed: Apr. 22, 2019

Related U.S. Application Data
(60) Provisional application No. 62/660,529, filed on Apr. 20, 2018.

(51) Int. Cl. G10K 5/00; A63H 5/00; A01K 15/02; G10K 3/00

(52) U.S. Cl. CPC G10K 5/00; A63H 5/00; G10K 3/00; A01K 15/026; A01K 15/025

(57) ABSTRACT

A multi-sound generating device for a toy, the multi-sound generating device including a body member having an inner chamber formed therein, a plurality of noise emitting members operationally disposed within the body member, the plurality of noise emitting members including a first noise generating member that emits a first sound when the body is manipulated, a second noise generating member that emits a second sound when the body is manipulated; and a third noise generating member that emits a third sound when the body is manipulated, whereby the first, second, and third sounds can be emitted simultaneously or separately.

### CROSS REFERENCE TO RELATED APPLICATION

The present application claims priority to U.S. Provisional Application No. 62/660,529, filed Apr. 20, 2018, the entire contents of which is incorporated herein for all purposes by this reference.

### TECHNICAL FIELD

The present invention pertains to toys or other amusement devices including, without limitation, dog toys or child toys. More particularly, the present invention pertains to toys that emit sounds or noises that are pleasing to animals, children, or others. More particularly still, in one embodiment, the present invention pertains to a durable toy that can generate or emit a plurality of audible sounds or noises, particularly when physically contacted or manipulated, such as by a dog or other pet, child or other user.

### BACKGROUND

Many conventional toys for dogs and other pets, employ some form of “noise-maker”—such as a squeaker—for generating audible sounds that are generally enjoyable to pets, as well as other animals and their companions.

For example, dogs like noise making toys. They like the feedback of a sound coming from the toy when they bite on it. They are stimulated by the auditory feedback, even if it sounds nothing like a real prey animal. The sound that comes from their biting action tells them they have an effective bite that is enough to create a reaction. The sound tells the dog to continue biting, whereas a toy without a squeaker or sound maker gives no feedback at all. Dogs descended from wolves and it is this predator and prey relationship that attracts dogs to sound making toys, such as squeakers. For example, the squeak in the toy sounds like an animal that is injured or scared. This sparks the dog's inner drive to attack. However, once the toy stops making noise, such as when the dog breaks the squeaker, the dog loses interest in the toy because it has successfully “killed” its prey. Noise making toys also offer health benefits. Allowing a dog to act on its instincts is healthy for them. In other words, letting them “hunt” their squeaky toy lets them relieve energy and reduces the chances that they will chew items that are not toys, such as shoes, furniture, etc. The noise maker can also get the dog's attention.

Conventional noise maker toys are typically capable of generating a single sound or noise. A need exists for a single toy that can generate or emit multiple different sounds or noises from the same toy, which will be more interesting to the dog or child and keep their interest longer. The toy should be durable, scalable and cost-effective to manufacture. However, such technologies do not exist. Accordingly, this disclosure enables such technologies.

### SUMMARY

To achieve the foregoing objects, and in accordance with the purpose of the invention as embodied and broadly described herein, there is provided a multi-sound emitting device that can be used alone or in conjunction with a toy, such as a dog or child toy, which includes a body member having an inner chamber formed therein, a plurality of noise emitting members operationally disposed within the body member, the plurality of noise emitting members including a first noise generating member that emits a first sound when the body is manipulated, a second noise generating member that emits a second sound when the body is manipulated, and a third noise generating member that emits a third sound when the body is manipulated, whereby the first, second, and third sounds can be emitted simultaneously or separately.

According to an embodiment of the invention, the first noise generating member may have a substantially cylindrical outer shape defining a central through bore thereby forming a sleeve structure within the body member.

According to an embodiment of the invention, the body member may include a first main member and a second member attached to a top portion of the first main member, wherein the first main member has a bottom opening formed therein that is configured to receive at least a portion of the second noise generating member, wherein the second member has a top opening formed therein that is configured to receive at least a portion of the third noise generating member, and wherein the first main member further includes a housing member that extends upward from a bottom portion of the first main member and within the inner chamber, the first main member configured to receive at least a portion of the second noise generating member, whereby a space is provided between the housing member and an interior side surface of the first main member that is configured to receive the first noise generating member.

According to an embodiment of the invention, a space may be formed between a top surface of the second sound generating member and a bottom surface of the third sound generating member.

According to an embodiment of the invention, the third sound generating device may extend inside of the sleeve structure of the first noise generating member.

According to an embodiment of the invention, the first noise generating member may be at least partially constructed of a polyethylene terephthalate (PET) material such that when force is applied thereto, the PET material deflects and emits the first sound.

According to an embodiment of the invention, a thickness of the PET material in relation to a thickness of an exterior surface of the body member is correlative to the volume of audible sound generated by the first noise generating member, such that when the thickness of the PET material is increased while the thickness of the exterior surface of the body member remains constant, the audible volume increases, and when the thickness of the PET material is decreased while the thickness of the exterior surface of the body member remains constant, the audible volume decreases.

According to an embodiment of the invention, a top surface of the second noise generating member may extend above a top surface of the housing member, and a top surface of the first noise generating member may extend above the top surface of the housing member.

According to an embodiment of the invention, the first main member and the second member may be integrally formed as a single unitary structure.

According to an embodiment of the invention, the first main member may include a first rim structure formed at a top portion of the first main member, and the second member may include a second rim structure formed at a bottom portion of the second member, whereby the first and second rim structures may have substantially the same shape and fit in engagement against each other when joined together.

According to an embodiment of the invention, the first and second rim structures may be joined together by mechanical fastening, adhesive bonding, or welding, after the first sound generating member is disposed inside the first main member.

According to an embodiment of the invention, the second noise generating member may include a flange member extending at least partially around an outer surface of a main cylindrical body portion of the second noise generating member, the flange member having one or more air holes formed therein, and a sliding component that moves the length of the interior space of the main cylindrical body portion by gravity or centrifugal motion, whereby the sliding component emits the second sound when the body member is manipulated or moved along various axes.

According to an embodiment of the invention, the bottom opening may include a chamfered structure configured to receive the rim flange member of the second noise generating device such that at least a portion of the rim flange member does not protrude outside of the body member.

According to an embodiment of the invention, the body member may be a spherical or an ellipsoidal shape.

According to an embodiment of the invention, the first sound may be a “crunching” sound, the second sound may be a “giggling” sound, and the third sound may be a “squeaking” sound.

### BRIEF DESCRIPTION OF THE DRAWINGS

The accompanying drawings constitute a part of this specification and illustrate an embodiment of the present disclosure and together with the specification, explain the present disclosure.

FIG. 1 shows a side perspective view of a body member of the toy according to an embodiment of the present invention.

FIG. 2 shows a side perspective view of a cap member of the toy according to an embodiment of the present invention.

FIG. 3 shows a side perspective view of a first noise generating member according to an embodiment of the present invention.

FIG. 4A shows a side view of a second noise generating member according to an embodiment of the present invention.

FIG. 4B shows a top view of a sliding component of the second noise generating member according to an embodiment of the present invention.

FIG. 4C shows a side view of the sliding component of the second noise generating member according to an embodiment of the present invention.

FIG. 5 shows a side view of a third noise generating member according to an embodiment of the present invention.

FIG. 6 shows a partially exploded side view of the toy according to an embodiment of the present invention.

FIG. 7 shows a partially exploded view of the toy according to an embodiment of the present invention.

FIG. 8A shows a partially exploded side view of the toy according to an embodiment of the present invention.

FIG. 8B shows a side sectional view of the toy according to an embodiment of the present invention.

FIG. 9A shows a partially exploded side view of the toy according to an embodiment of the present invention.

FIG. 9B shows a side sectional view of the toy according to an embodiment of the present invention.

FIG. 10 shows a side perspective view of the toy according to an embodiment of the present invention.

### DETAILED DESCRIPTION OF THE PREFERRED EMBODIMENTS

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

As used herein, various singular forms “a,” “an” and “the” are intended to include various plural forms as well, unless context clearly indicates otherwise. For example, a term “a” or “an” shall mean “one or more,” even though a phrase “one or more” is also used herein. Use of the optional plural “(s),” “(es),” or “(ies)” means that one or more of the indicated feature is present.

As used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, features described with respect to certain embodiments may be combined in or with various other embodiments in any permutational or combinatory manner. Different aspects or elements of example embodiments, as disclosed herein, may be combined in a similar manner.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

The term “geometrically-shaped” as used herein includes circular, polygon, rectangular, square, and triangular shapes.

The present invention comprises a material that can be used for the manufacture of various objects such as pet toys including, without limitation, chewable dog toys. The material is stronger, more durable, and more resilient than conventional fabric or synthetic sheet material. In a preferred embodiment, the material should be capable of generating or emitting audible sounds or noises, particularly when physically contacted or manipulated by a pet (such as a dog) or other external force acting on the material.

The present invention comprises a toy, such as a pet or child toy, (including, without limitation, a chewable dog toy). In a preferred embodiment, the toy of the present invention is capable of generating or emitting audible sounds or noises, particularly when physically contacted or manipulated by a pet (such as a dog), person or other external force acting on the toy. By way of illustration, but not limitation, the toy of the present invention can comprise a spherical or ellipsoidal shape; however, the toy of the present invention can also embody other shapes or configurations without departing from the scope of the present invention.

In a preferred embodiment, the toy of the present invention includes an inner chamber or hollow section that is at least partially collapsible and has an outlet port or aperture. In this configuration, the toy mimics or acts like a bellows—the toy emits a stream of air through the outlet port or aperture when the chamber or hollow section is squeezed or compressed together, such as when a dog or other pet bites down on or otherwise compresses the toy. This stream of pressurized air is directed through a noise generating device to emit an audible sound—such as a “squeak”; such noise is generally pleasing to a dog (or other pet) when the dog bites down on the toy, or to a child or other user when the toy is squeezed.

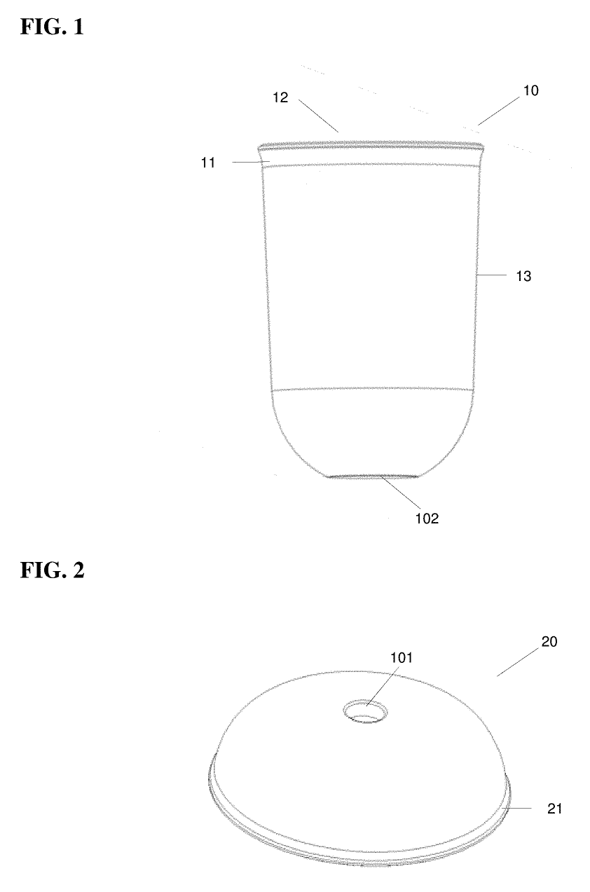

Referring to the drawings, FIG. 1 depicts a side perspective view of a body member 10 of the toy according to an embodiment of the present invention. Body member 10 defines an inner hollow area or chamber 12, and upper rim 11. A central substantially hollow and cylindrical housing member 13 extends within the inner chamber 12. In a preferred embodiment, the central housing member 13 is centered within the inner chamber 12, and shares a central longitudinal axis with the inner chamber 12. As described below, a second noise generating member 40 may be provided inside the cylindrical housing member 13.

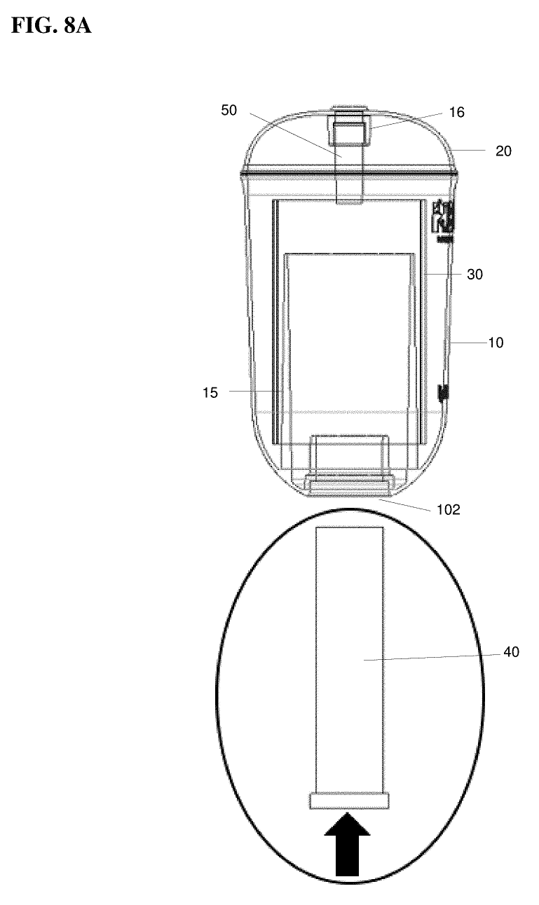

Body member 10 includes a bottom end opening 102. As described in more detail below, the bottom end opening 102 is configured to receive the second noise generating member 40. Bottom end opening 102 is preferably formed with a chamfered structure 46 configured to receive a rim flange member 41 of second noise generating member 40 such that at least a portion of rim flange member 41 does not protrude outside of body member 10 (such as shown in exemplary FIGS. 7-9B).

Body member 10 may be formed with a first inwardly extending section 15 configured to receive at least a portion of second noise generating member 40. First inwardly extending section 15 may extend partially along the longitudinal axis of body member 10 from a bottom portion of body member 10. First inwardly extending section 15 may be sized and shaped to tightly receive at least a portion of second noise generating member 40, such as shown in exemplary FIG. 7. First inwardly extending section 15 may function to maintain positive air pressure within body member 10 and/or tightly hold second noise generating member 40 in place. First inwardly extending section 15 is preferably formed inside of hollow chamber 12. First inwardly extending section is preferably formed integral with body member 10.

Body member 10 preferably comprises an thermoplastic elastomer (TPE) polymer, but is not limited thereto. TPE polymer has excellent spring-like quality, high tensile strength (able to withstand wear and tear), and is highly pliable. TPEs are also non-toxic and environmentally friendly, making them safe for both child and animal use, as well as water-resistant. Body member 10 may comprise other materials, such as low density polyethylene (LDPE), synthetic rubber, natural rubber, etc.

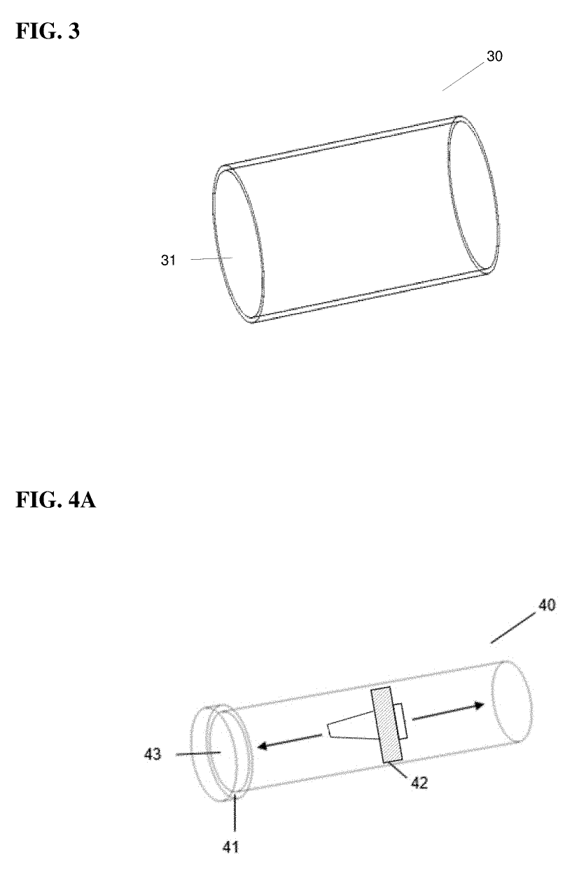

FIG. 2 depicts a side perspective view of a cap member 20 of the toy according to an embodiment of the present invention.

Cap member 20 includes a top end opening 101 (outlet port or aperture) formed therein. Top end opening 101 is configured to receive a third noise generating member 50. Cap member 10 may be formed with a second inwardly extending section 16 configured to receive at least a portion of third noise generating member 50. Second inwardly extending section 16 may extend partially along the longitudinal axis of body member 10 from a top portion of cap member 20. Second inwardly extending section 16 may be sized and shaped to tightly receive at least a portion of third noise generating member 50, such as shown in exemplary FIG. 7. Second inwardly extending section 16 is preferably formed integral with cap member 20 and extends at least a portion of the length of third noise generating member 50 when third noise generating member 50 is disposed therein. The bottom end opening 102 may be larger than the top end opening 101

Top end opening 101 may extend through the cap member and define rim 21. Top end opening 101 is preferably circular, but can be any shape. In a preferred embodiment, rim 21 is substantially the same shape, size and configuration as upper rim 11 of body member 10. As such, rim 21 of cap member 20, and rim 11 of body member 10, may fit in engagement against each other when joined together in mating relationship. The cap member 20 and rim 11 may be joined together by mechanical fastening (e.g., snap fit, threaded together), adhesive bonding (e.g., glue), welding (e.g., heat sealing, heat fusion, heat welding, butt welding), or the like.

Although not shown herein, it is understood that top end opening 101 may be formed with a chamfered structure 56 and configured to receive a rim flange member 51 of third noise generating member 50 such that at least a portion of rim flange member 51 does not protrude outside of body member 10. It is also understood that body member 10 and cap member 20 may alternatively be formed as a unitary structure.

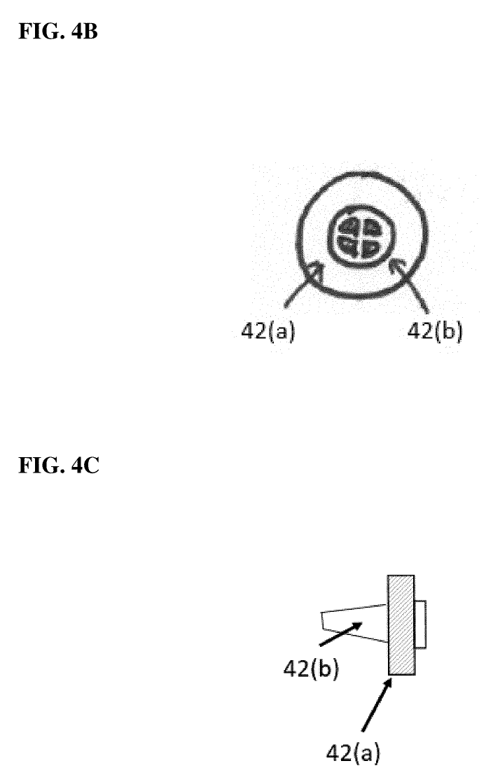

FIG. 3 depicts a side perspective view of a first noise generating member 30 according to an embodiment of the present invention. In a preferred embodiment, the first noise generating member 30 has a substantially cylindrical outer shape defining a central through bore 31, thereby forming a sleeve. However, it is understood that first noise generating member 30 can be any shape, size, or configuration. Further, in a preferred embodiment, first noise generating member 30 is at least partially constructed of polyethylene terephthalate (“PET”), although other materials having desirable sound emitting characteristics or qualities can be utilized without departing from the scope of the invention.

Still referring to FIG. 3, first noise generating member 30 “crinkles” when force is applied thereto, causing the material of first noise generating member 30 to deflect, bend or deform, thereby emitting an audible “crunching” or “crinkling” sound. In a preferred embodiment, the thickness of the material forming noise generating member 30 can be adjusted to selectively affect the volume of the sound generated by the member 30. For example, thickness of the material can be increased in order to selectively increase the volume of audible sound generated by first noise generating member 30, or decreased in order to selectively decrease the volume of audible sound generated by first noise generating member 30.

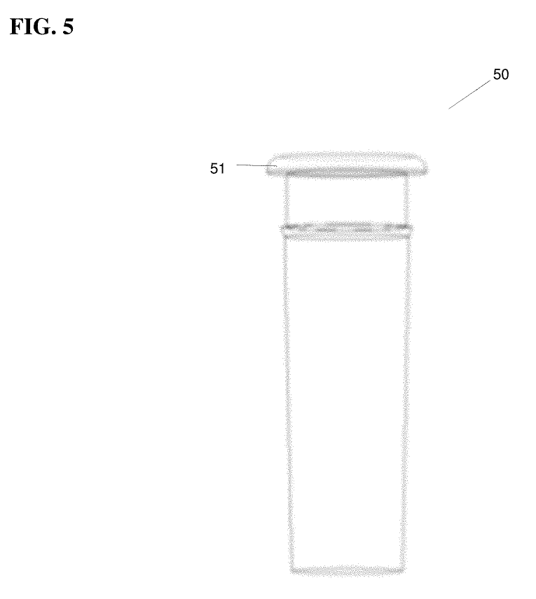

FIGS. 4A depicts a side view of a second noise generating member 40 according to an embodiment of the present invention. FIGS. 4B and 4C depict a top view and side view of the sliding component 42 of the second noise generating member 40, respectively. Looking at FIG. 4A, in a preferred embodiment, second noise generating member 40 is substantially tubular or cylindrical. Second noise generating member 40 may include a tubular member 44 and a rim flange member 41 extending at least partially around an outer surface of the tubular member 44. Tubular member 44 is preferably closed (i.e., no air holes) at an end thereof that is opposite rim flange member 41. Rim flange member 41 may be formed integral with tubular member 44 or affixed thereto. Rim flange member 41 may be a plastic cap with one or more air holes that is bonded (e.g., welded, glued, or snap fitted) onto an end portion of tubular member 44.

Second noise generating member 40 includes a sliding component 42 that moves the length of the interior space 43 of tubular member 44 by gravity or centrifugal motion.

Accordingly, sliding component 42 emits sound when second noise generating member 40 or body member 10 is moved along various axes. More particularly, second noise generating member 40 emits a “giggle” or other sound when physically contacted or manipulated by external force(s) acting on the body member 10 or toy 100.

As shown in exemplary FIGS. 4B and 4C, sliding component 42 may comprise a hollow member slide component 42(a) and a squeaker component 42(b). The hollow member slide component 42(a) is preferably formed of metal (not limited thereto) so that it has sufficient weight to move or slide back and forth through the interior space 43 of tubular member 44 by gravity or centrifugal motion forcing air through the squeaker component 42(b) assembled into the center of the hollow member slide component 42(a). The hollow member slide component 42(a) is preferably ring shaped and surrounds a circumference of a portion of squeaker component 42(b) such that a portion of squeaker component 42(b) extends above and below the hollow member slide component 42(a), as shown. Preferably, squeaker component 42(b) has a tapered elongated portion that extends from the hollow member slide component 42(a). As shown in FIG. 4B, squeaker component 42(b) comprises air holes whereby air is forced in and out of the squeaker component 42(b) during manipulation of the body member 10 or toy 100. Air is forced in and out of squeaker component 42(b) at both longitudinal ends thereof during manipulation of the body member 10 or toy 100. Accordingly, sound is activated by air being forced through the squeaker component 42(b), when the sliding component 42(a) moves back and forth through the interior space 43 of tubular member 44 causing the giggling sound. The giggling sound happens as a result of the squeaker moving back and forth through the interior space 43 of tubular member 44 which baffles the squeaker sound into a giggling sound.

Rim flange member 41 contains one or more air holes (not shown) that allow air into and out of second noise generating member 40 as well as allow sound produced by sliding component 42 to escape second noise generating member 40. Thus, upon physical compression or decompression of body member 10, air may be directed into and through one or more air holes of rim flange member 41, through interior space 43, through sliding component 42, exit body member 10 through one or more air holes, and emit sound.

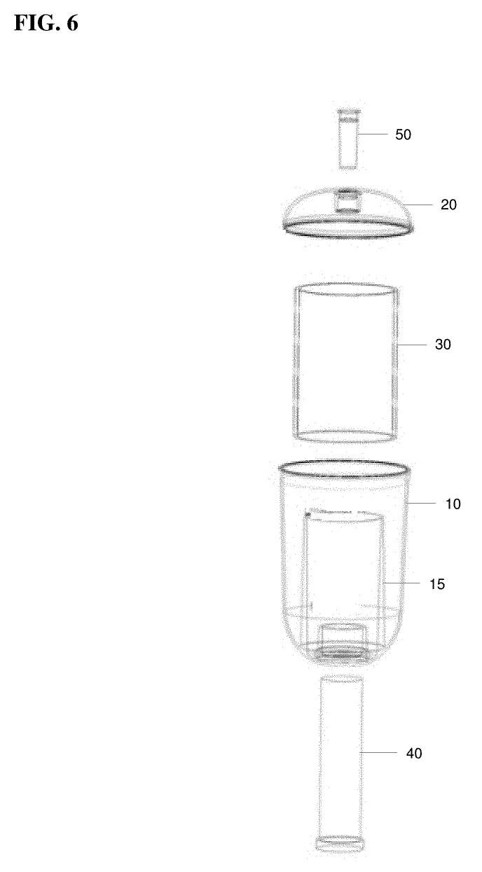

FIG. 5 depicts a side view of a third noise generating member 50 according to an embodiment of the present invention. In a preferred embodiment, third noise generating member 50 is substantially tubular or cylindrical. Third noise generating member 50 may include a tubular member 52 and a rim flange member 51 extending at least partially around the outer surface of the tubular member 52. Rim flange member 51 may be integrally formed with tubular member 52 or affixed to an end portion thereof. Rim flange member 51 contains air holes (not shown) that allow air into and out of third noise generating member 50 as well as allow sound produced by third noise generating member 50 to escape body member 10 or toy. Third noise generating member 50 emits a “squeak” when pressurized air flows through the member 50.

For example, when body member 10 or toy is squeezed, air is forced through third noise generating member 50 or squeaker, resulting in a high-pitched sound, such as a squeak or whistle. The tone and duration of the sound may depend on the size of the squeaker, the amount of air squeezed out of body member 10 or toy, and the speed with which it is squeezed. When body member 10 or toy is not squeezed, body member 10 resumes its normal shape and re-inflates. Air returning into body member 10 or toy through third noise generating member 50 or squeaker may or may not make a sound.

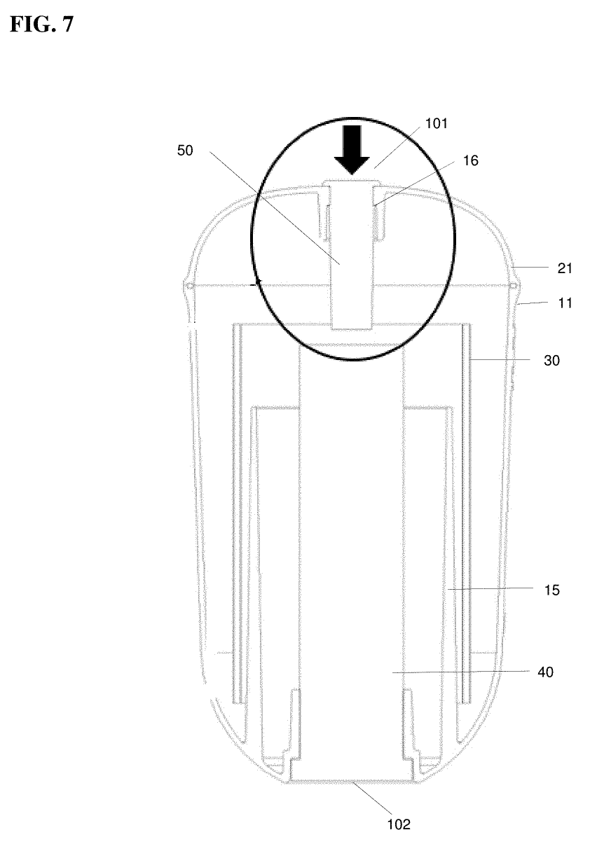

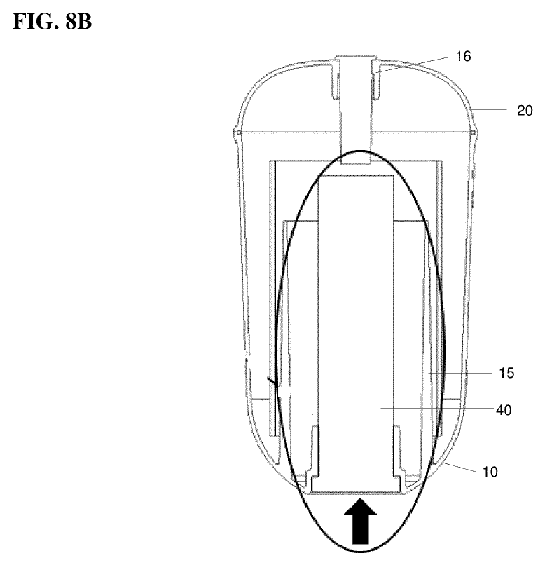

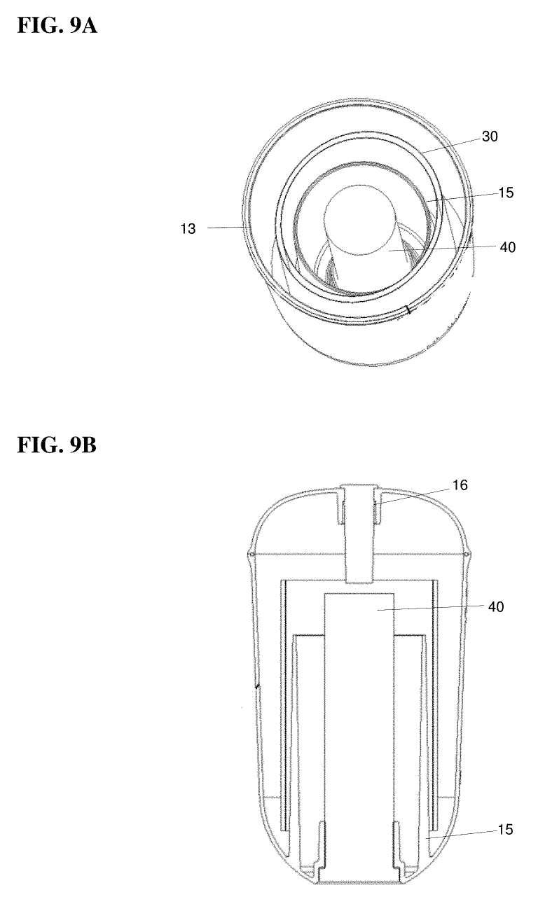

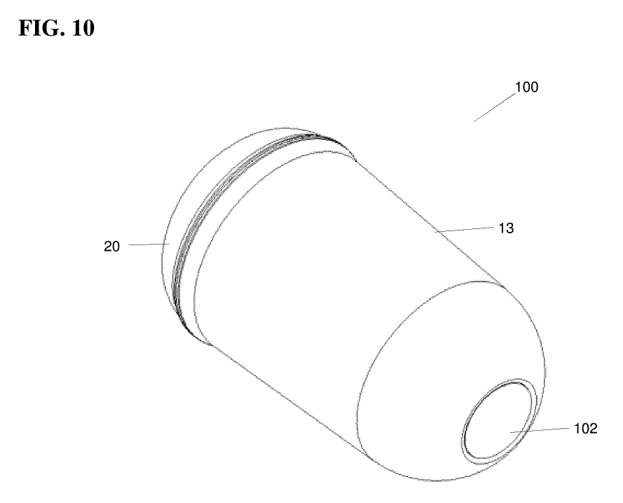

FIG. 6 depicts a partially exploded side view of the toy 100 according to an embodiment of the present invention. FIG. 7 depicts a partially exploded view of the toy 100 according to an embodiment of the present invention. FIG. 8A depicts a partially exploded side view of the toy 100 according to an embodiment of the present invention, while FIG. 8B depicts a side sectional view of the toy 100 of the present invention. FIG. 9A depicts a partially exploded side view of the toy 100 according to an embodiment of the present invention, while FIG. 9B depicts a side sectional view of the toy 100 according to an embodiment of the present invention. FIG. 10 depicts a side perspective view of the toy 100 according to an embodiment of the present invention.

Referring to FIGS. 6-10, first noise generating member 30 is installed within body member 10. For example, as shown, first noise generating member 30 may be disposed between an outer surface of cylindrical housing member 13 and an inner surface of body member 10. It is understood that cylindrical housing member 13 or similar structure is preferable but not required. First noise generating member 30 may extend the entire length of body member 10 or a portion thereof. First noise generating member 30 may extend circumferentially about an interior of body member 10 or a portion thereof.

Cap member 20 may be joined to body member 10. For example, rim 21 of cap member 20 and rim 11 of body member 10 may be joined in a mating relationship and heat welded, glued or otherwise secured together. It is understood that body member 10 may alternatively be formed as a unitary structure having the structural features of cap member 20 such that cap member 20 is not necessary. In such embodiment, first noise generating member may be installed inside of body member 10 through top opening 101.

Second noise generating member 40 may be installed through bottom opening 102 of body member 10 and within the central substantially hollow and cylindrical housing member 13 or inwardly extending section 15. Preferably, bottom end opening 102 is formed with chamfered structure 46 that is configured to receive rim flange member 41 of second noise generating device such that at least a portion of rim flange member 41 does not protrude outside of body member 10. Preferably, at least a portion of rim flange member 41 fits snugly (tightly) inside of bottom opening 102 (e.g., press fit).

Third noise generating member 50 may be installed within aperture 22 of cap member 20. The top end opening 101 may be formed with chamfered structure 56 that is configured to receive rim flange member 51 of third noise generating device such that at least a portion of rim flange member 51 does not protrude outside of body member 10 (not shown). Preferably, third noise generating member 50 fits snugly (tightly) inside of top end opening 101 (e.g., press fit).

Toy 100 of the present invention, which can be beneficially used by dogs, other animals or humans, can generate multiple different audible sounds or noises when force is applied to the toy 100. The type and volume of the sounds/noises can vary depending on the type, intensity, direction and means of application of such force. For example, the force can vary depending on how an animal bites, bends, folds, tosses, carries, compresses or otherwise manipulates the toy 100.

By way of example, but not limitation, first noise generating member 30 can generate a “crunching” or “crinkling” sound, second noise generating member 40 can generate a “giggling” sound, and third noise generating member 50 can generate a “squeaking” sound. Such noises or sounds, which can be emitted simultaneously or separately, are generally enjoyable to pets, as well as other animals and their companions, thereby motivating play with the toy 100. This multi-sound emitting structure may be referred to as a “chatter box.”

It is understood that the multi-sound emitting structure described above can employ more than one first noise generating member 30 each formed of the same or different material having the same or different thickness; one or more second noise generating member 40 each formed having the same or different size and shape; and/or one or more third noise generating member 50 each having the same or different size.

It is further understood that the multi-sound emitting structure described above is not limited to any particular size or configuration, and is configured to be installed inside of a toy 100, such as a pet or child toy, having any configuration (e.g., ball, plush toy, doll, etc.), or used alone as the toy 100 itself.

The above-described invention has a number of particular features that should preferably be employed in combination, although each is useful separately without departure from the scope of the invention. While the preferred embodiments of the present invention are shown and described herein, it will be understood that the invention may be embodied otherwise than herein specifically illustrated or described, and that certain changes in form and arrangement of parts and the specific manner of practicing the invention may be made within the underlying idea or principles of the invention.

The above-described invention has a number of particular features that should preferably be employed in combination, although each is useful separately without departure from the scope of the invention. While the preferred embodiments of the present invention are shown and described herein, it will be understood that the invention may be embodied otherwise than herein specifically illustrated or described, and that certain changes in form and arrangement of parts and the specific manner of practicing the invention may be made within the underlying idea or principles of the invention.

Although the invention is described herein with reference to specific embodiments, it is understood that various modifications and changes can be made without departing from the scope of the present invention.

What is claimed is:

1. A multi-sound generating device, comprising:
a body member having an inner chamber formed therein;
a plurality of noise emitting members operationally disposed within the body member, the plurality of noise emitting members comprising:
a first noise generating member that emits a first sound when the body is manipulated;
a second noise generating member that emits a second sound when the body is manipulated; and
a third noise generating member that emits a third sound when the body is manipulated, whereby the first, second, and third sounds can be emitted simultaneously or separately.

2. The multi-sound generating device, wherein the first noise generating member has a substantially cylindrical outer shape defining a central through bore thereby forming a sleeve structure within the body member.

3. The multi-sound generating device of claim 2, wherein the body member comprises a first member and a second member attached to a top portion of the first member,
wherein the first member has a bottom opening formed therein that is configured to receive at least a portion of the second noise generating member,
wherein the second member has a top opening formed therein that is configured to receive at least a portion of the third noise generating member.

4. The multi-sound generating device of claim 3, wherein the first member further comprises a housing member that extends upward from a bottom portion of the first member and within the inner chamber, the housing member configured to receive at least a portion of the second noise generating member,
whereby a space is provided between the housing member and an interior side surface of the first main member that is configured to receive the first noise generating member.

5. The multi-sound generating device of claim 3, wherein a top surface of the second sound generating member is spaced apart from a bottom surface of the third sound generating member.

6. The multi-sound generating device of claim 3, wherein the third sound generating device extends inside of the sleeve structure of the first noise generating member.

7. The multi-sound generating device of claim 6, wherein the first noise generating member is at least partially constructed of a polyethylene terephthalate (PET) material such that when force is applied thereto, the PET material deflects and emits the first sound which is a “crunching” sound.

8. The multi-sound generating device of claim 7, wherein a thickness of the PET material in relation to a thickness of an exterior surface of the body member correlates to the volume of audible sound generated by the first noise generating member, such that when the thickness of the PET material is increased while the thickness of the exterior surface of the body member remains constant, the audible volume increases, and when the thickness of the PET material is decreased while the thickness of the exterior surface of the body member remains constant, the audible volume decreases.

9. The multi-sound generating device of claim 4, wherein a top surface of the second noise generating member extends above a top surface of the housing member, and
wherein a top surface of the first noise generating member extends above the top surface of the housing member.

10. The multi-sound generating device of claim 3, wherein the first main member and the second member are integrally formed as a single unitary structure,

11. The multi-sound generating device of claim 3, wherein first main member comprises a first rim structure formed at a top portion of the first main member, and the second member comprises a second rim structure formed at a bottom portion of the second member,
wherein the first and second rim structures have substantially the same shape and fit in engagement against each other when joined together.

12. The multi-sound generating device of claim 11, wherein the first and second rim structures are joined together by mechanical fastening, adhesive bonding, or welding, after the first sound generating member is disposed inside the first main member.

13. The multi-sound generating device of claim 12, wherein the second noise generating member comprises:
a flange member extending at least partially around an outer surface of a main cylindrical body portion of the second noise generating member, the flange member comprising one or more air holes, and
a sliding component that moves the length of the interior space of the main cylindrical body portion by gravity or centrifugal motion,
whereby the sliding component emits the second sound when the body member is manipulated or moved along various axes.

14. The multi-sound generating device of claim 13, wherein the bottom opening comprises a chamfered structure configured to receive the rim flange member of the second noise generating device such that at least a portion of the rim flange member does not protrude outside of the body member.

15. The multi-sound generating device of claim 14, wherein the body member comprises a spherical or ellipsoidal shape.

16. The multi-sound generating device of claim 1, wherein the first sound is a “crunching” sound, the second sound is a “giggling” sound, and the third sound is a “squeaking” sound.

17. A pet toy comprising:
an exterior body forming an exterior appearance of the pet toy,
a multi-sound generating device provided inside the exterior body, wherein the multi-sound generating device comprises:
a body member having an inner chamber formed therein;
a plurality of noise emitting members operationally disposed within the body member, the plurality of noise emitting members comprising:
a first noise generating member that emits a first sound when the body is manipulated;
a second noise generating member that emits a second sound when the body is manipulated; and
a third noise generating member that emits a third sound when the body is manipulated,
whereby the first, second, and third sounds can be emitted simultaneously or separately.

18. The pet toy of claim 17, wherein the first noise generating member is at least partially constructed of a polyethylene terephthalate (PET) material such that when force is applied thereto, the PET material deflects and emits the first sound,
wherein the first noise generating member has a substantially cylindrical outer shape defining a central through bore thereby forming a sleeve structure within the body member.
wherein the third sound generating device extends inside of the sleeve structure of the first noise generating member.

19. The pet toy of claim 18, wherein the body member comprises a first member and a second member attached to a top portion of the first member,
wherein the first member has a bottom opening formed therein that is configured to receive at least a portion of the second noise generating member; and
wherein the second noise generating member comprises:
a flange member extending at least partially around an outer surface of a main cylindrical body portion of the second noise generating member, the flange member comprising one or more air holes, and
a sliding component that moves the length of the interior space of the main cylindrical body portion by gravity or centrifugal motion,
whereby the sliding component emits the second sound when the body member is manipulated or moved along various axes; and
wherein the bottom opening comprises a chamfered structure configured to receive the rim flange member of the second noise generating device such that at least a portion of the rim flange member does not protrude outside of the body member.

20. The pet toy of claim 16, wherein the first sound is a “crunching” sound, the second sound is a “giggling” sound, and the third sound is a “squeaking” sound.
